(19) United States
(12) Patent Application Publication
(10) Pub. No.: US 2002/0178225 A1
(43) Pub. Date: Nov. 28, 2002

(54) System and method for providing on-line extensions of off-line places and experiences

(75) Inventors: Douglas Madenberg, Great Neck, NY (US); Adam Greene, New York, NY (US)

Correspondence Address: Steven Fischman, SCULLY, SCOTT, MURPHY & PRESSER, 400 Garden City Plaza, Garden City, NY, 11530, US

(73) Assignee: M&G Enterprises LLC, Great Neck, NY (US)

(21) Appl. No.: 09/865,095

(22) Filed: May 24, 2001

(51) Int. Cl. G06F 15/16

(52) U.S. Cl. 709/206; 709/217

(57) ABSTRACT

A web-based service that facilitates the on-line reconnecting or linking up of people who have had a previous encounter in a prior off-line, locally-based context, e.g. at a place, event, or venue such as bar, subway, or in passing, and wanted to meet, but where one person did not have the opportunity at the time to approach the other person or had not seized the prior opportunity to pursue. Implementing web-based communication and e-mail messaging techniques, the web-enabled service provides functionality that enables registered users to post messages, that are directed to a person who may have had a brief prior experience, interaction or moment together with the user at a prior place and time. These messages are posted in a public place for all viewers to see, in hopes that the individual the user is trying to re-connect with sees it and responds. Functionality is provided so that the individual who chooses to respond to a particular message posting may do so anonymously, via masked e-mail messaging service. Thus, people hoping to re-connect will be able to create a private dialogue via e-mail by responding to one another's messages.

### BACKGROUND OF THE INVENTION

1. Field of the Invention

This invention relates generally to dating and on-line meeting services, and more specifically, to a web-based connection service that facilitates the extension of opportunities for two people to meet who have already had a previous interaction off-line.

2. Discussion of the Prior Art

In today's busy world, it is often hard for single people to meet each other. Traditional dating services that provide people with opportunities to meet other people through vehicles such as activity services, personal ads, and the like, have been successful and have withstood that test of time. However, some of the opportunities provided by these traditional services are limited in that the people desirous of meeting people either have limited knowledge of what the other person looks like, e.g., in the case of newspaper personal ads which may result in a “blind date” meeting, or, only have knowledge of certain likes and dislikes based on profile entries. For example, in the case of a sponsored “singles” event, where it is assumed that the people participating have a commonality, i.e., they like to engage in the event activity, such as a dance, and hence, increase their likelihood of finding a desirable “match”. More sophisticated and generally more expensive services are available such as videotaped interviews and screening that enable people to physically “view” other people prior to their meeting. This service is typically expensive and requires time expenditure on the part of the person preparing the videotape and the person who will be doing the viewing.

The Internet has additionally provided a myriad of other options for those who want to meet or date other people, akin to the traditional dating services now available. For example, there are numerous on-line/web-based matchmaking sites, personals listings and “secret admirer” sites that enable people to meet. Generally, the common thread among these dating services is that an indirect source—a written description (with a possible flattering photo), a matchmaking database, a “neutral” third party, or a contrived “singles event” —attempts to match people with similar profiles and desires. However, these situations are all “hit” and (usually) “miss”. The problem is, not even the best-written personal ad or most powerful database can predict or create the true basic and essential component of a romantic relationship: the existence of a “spark” or sense of attraction or connection between two people.

It would be highly desirable to provide a web-based application that enables people to reconnect after such a moment of spark has already taken place in an off-line context.

It would be highly desirable to provide a function related to these dating and matchmaking alternatives that is more of a connection service which bridges the gap between two people who already know they want to meet, or, one person who had the opportunity to meet the other but had relinquished the moment or was prevented from seizing it.

### SUMMARY OF THE INVENTION

Accordingly, it is an object of the present invention to provide a web-based service which facilitates the reconnection or linking up of people desirous of meeting one another, directly by the parties involved, without the participation of or intervention of third parties or other intermediary.

It is another object of the present invention to provide a web-based service that enables a person to extend the opportunity to contact another person with whom that person may have had a prior off-line experience or interaction with, for example, a person who had seen the other person in a prior context, e.g. a bar, subway, or in passing, but where that person did not have the opportunity at the time to approach the other person.

It is a further object of the present invention to provide a web-based service that enables a person to post a message associated with a specific venue, date, time or event where a prior off-line experience or interaction between that person and another had occurred, which message may be subsequently viewed on-line by that other person and responded to confidentially, for the purpose of extending that prior experience or interaction.

It is yet another object of the present invention to provide a web-based service that enables users to post messages associated with their frequenting of a local venue or event, and which messages may be subsequently viewed by other people on-line who wish to get a better feel for a specific venue/event before actually frequenting the specific venue or event.

It is yet another object of the present invention to provide a web-based service that enables users to post messages associated with member-created events, which occur at specific bars/clubs and other social venues and functions.

It is a further object of the present invention to provide a web-based service that enables web-based posting of advertisements of products directed to and information targeted for particular audiences who frequent locally based venues or attend local events, the targeted information and advertisements being provided to members when viewing messages posted by other people who have frequented specific local venues or events.

According to the principles of the invention, there is provided a system and method for extending off-line experiences between parties in an on-line context over a communications network, the method including the steps of: a) accessing a list of folder structures for on-line viewing via a web-browser device, each folder structure associated with a particular location where a prior off-line experience had taken place and including one or more messages submitted by persons that relate to continuing a specific prior interaction involving the person and another at the location; b) enabling the another person to select a folder and initiating display via the web-browser device of all messages submitted by users regarding their prior interactions at the associated venue in response to the selection; c) enabling the another person to select a message recognized as being submitted by the person and relating to a specific prior off-line experience with that person; and d) in response to said selection, providing a link enabling user generation of reply message for continuing said prior off-line experience between the person and the another person in an on-line context via the communication network.

Advantageously, the web-site of the present invention for providing a unique on-line extension of off-line places and experiences is inherently associated with localized events and venues. Consequently, the site becomes a provider of local content, information and entertainment thus, providing access to a potential market of people who regularly use web sites offering information about local events, restaurants, community activities, and regional news.

### BRIEF DESCRIPTION OF THE DRAWINGS

Further features, aspects and advantages of the apparatus and methods of the present invention will become better understood with regard to the following description, appended claims, and accompanying drawings where:

FIG. 1 is a diagram illustrating an Internet/Web-based communications environment employing the web-site providing the on-line connection service according to the invention;

FIG. 2 depicts an example generic HeyYouItsMe home screen 50 according to the invention;

FIG. 3 illustrates a process flow diagram for enabling new user registrations;

FIG. 4(a) is an example depiction of a HeyNotes™ web-page 70 presented to the user's web-browser in response to user selection of the HeyNotes™ link from the default zone page;

FIG. 4(b) illustrates an example pop-up reply window 100 displayed at the user's browser for enabling users to create a reply to a HeyNote message;

FIG. 4(c) illustrates an example inbox web-page conversation view including an Inbox frame 90 comprising truncated versions of all e-mail message replies that have retrieved from the user's Inbox;

FIG. 4(d) illustrates an example pop-up HeyNote creation window 110 displayed at the user's browser for enabling users to create a HeyNote message;

FIG. 4(e) illustrates an example pop-up add venue window 130 displayed at the user's browser that enables entry of a new venue to be added;

FIG. 4(f) is an example depiction of a HeyNotes™ web-page 70 including a plurality of advertisements paid for advertisers and site sponsors presented to the user's web-browser;

FIG. 5 is a block diagram depiction of the HeyNote creation process;

FIG. 6 depicts an example web-page 140 comprising a lists of upcoming events sponsored by members and third party venues for a particular zone;

FIG. 7 particularly shows a pop-up create event window 150 displayed at the user's browser enabling user to post an upcoming event notification.

### DETAILED DESCRIPTION OF THE PREFERRED EMBODIMENT

The present invention is a web-based service that facilitates the on-line reconnecting or linking up of people who have had a previous encounter in a prior off-line, locally-based context, e.g. at a place, event, or venue such as bar, subway, or in passing, and wanted to meet, but where one person did not have the opportunity at the time to approach the other person or had not seized the prior opportunity to pursue. Implementing web-based communication and e-mail messaging techniques, the web-site, referred to herein as “HeyYouItsMe,” enables registered users (“user”) to post messages, referred to herein as HeyNote™ , that are directed to a person who may have had a brief prior experience, interaction or moment together with the user at a prior place and time. These HeyNote messages are posted in a public place for all viewers to see, in hopes that the individual the user is trying to re-connect with sees it and responds.

Preferably, the web-site is structured to generate an interactive web-page, viewable by standard web-browsers, that enable users to navigate to the “zone”, e.g., a particular place or city, e.g. New York, the “Hamptons”, Miami, etc., and a particular “venue” that is selectable within that zone, e.g., a bar, club, restaurant, or “other place” such as a subway, airport, baseball stadium, passing by, a street comer, a wrong phone number, etc., and leave a HeyNote message. In response to user selection of a venue or other place, a publicly accessible area of the web-page display is populated with prior HeyNote message postings from other users which have been sent to a public folder. Thus, alternately, or in addition to posting a “HeyNote”, a user may browse through the previous message postings perhaps to locate a HeyNote message directed to that user in order to recapture a moment that person may have had with another. For ease of use, the prior HeyNote message postings displayed are presented within the web page in reverse chronologic order. While browsing through the HeyNote message postings, if a user recognizes a HeyNote directed to him/her self, that user may select the message and directly respond by way of an e-mail message which is communicated directly to a remote web-server and stored in a message inbox associated with the poster of the HeyNote message for later retrieval. Any reply e-mail message is for the user's eyes only and is not available for public viewing. At that point, a prior experience or moment may be recaptured and it is thereafter up to the participants as to how far the parties wish to extend it.

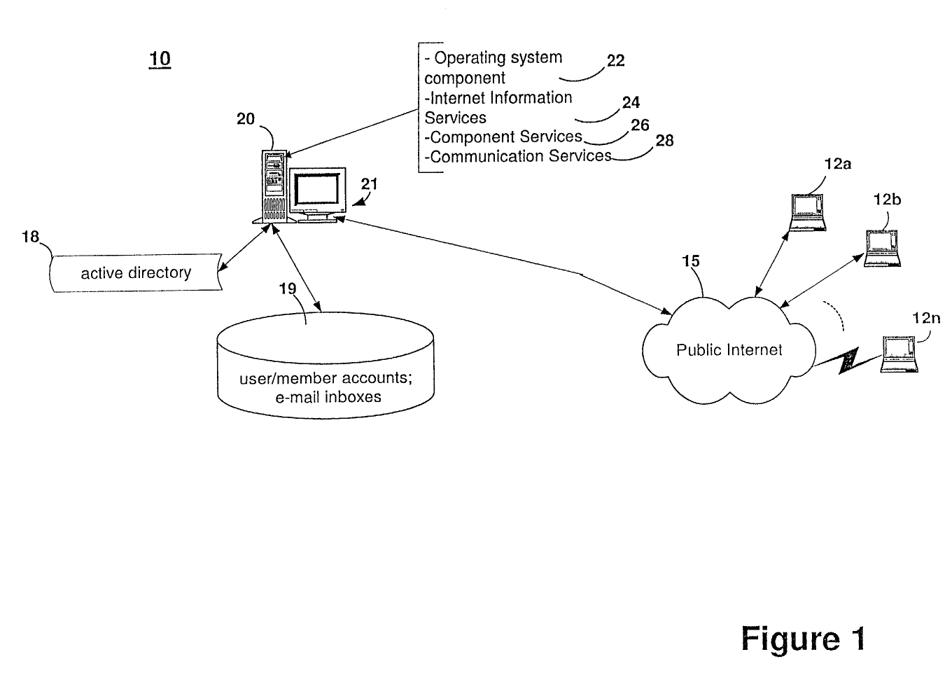

More particularly, FIG. 1 is a diagram illustrating an Internet/Web-based communications network 10 established for conducting on-line connection service for extending prior meetings in an off-line context. As shown in FIG. 1, the invention comprises a web site 21, (URL http://www.HeyYouItsMe.com), providing the on-line connection service over the Internet 15, that includes one or more web/database servers 20 comprising application and database software components as will be described in greater detail herein. Members, who sign with the service and visitors of the web site 12a, . . . , 12n alike, are enabled to access the Web site 21 remotely via wired or wireless connections to the Web/Internet 15. Wired communications between the web site 21 and the vendor public are via the public Internet in accordance with standard TCP/IP protocols and optionally, over a secure communications link, e.g., secure sockets layer, or similar protocol. It is understood that parties 12a, . . . , 12n may access the Web/Internet via a personal computer/computing device, personal digital assistant, or like device implementing web-browser functionality, e.g., Netscapet® or Internet Explorer 5.0®. As depicted in FIG. 1, the web-site server 20 employs hardware and software components configured to facilitate communication between people including, but not limited to: 1) domain controllers including: an Operating System (OS) component 22, e.g., such as Microsoft Windows 2000, that is utilized in all computers in the production network to provide the basic software platform upon which all other software mechanisms operate; and, an Active Directory (AD) component 18 that provides a database 19 of user accounts and user groups and, as will be described in greater detail, provides a security mechanism called a domain; and, 2) application server components including: Internet Information Services (IIS) 24 which is a mechanism enabling files on a computer to be read by remote computers and particularly, is used to house, secure and present a web site to either the Internet or an intranet (private network); Component Services (COM+) 26 which function as a repository of custom Dynamic Link Libraries (dll's) that allow custom applications to perform actions in data sources foreign to the application, e.g., enabling a web page to query data on a database, or create a new user in Active Directory; and, Communication Services 28 which include a server application such as provided by Microsoft Exchange 2000 that enables various electronic communications including, but not limited to: e-mail, chat rooms, video conferencing and news groups; and, provides a robust messaging infrastructure. Exchange 2000 also enables generation and management of public folders, which provide an accessible depository of messages submitted by any user with permissions to do so.

Visitors to the site will have the option to either become a member of the web-site 20, which would grant them full access to the site and use of it s functionality, or, as a non-member, provide the ability to view the static information areas of the site. Forcing membership to the site helps to discourage random postings and assist in controlling the site for what it is designed to provide as well as provide a means for tracking user activity. Through membership, users have the opportunity to establish an account with the service that will provide them with an internal e-mail account, an account profile and ability to specify preferences, such as the ability to choose a default login zone page, as will be described.

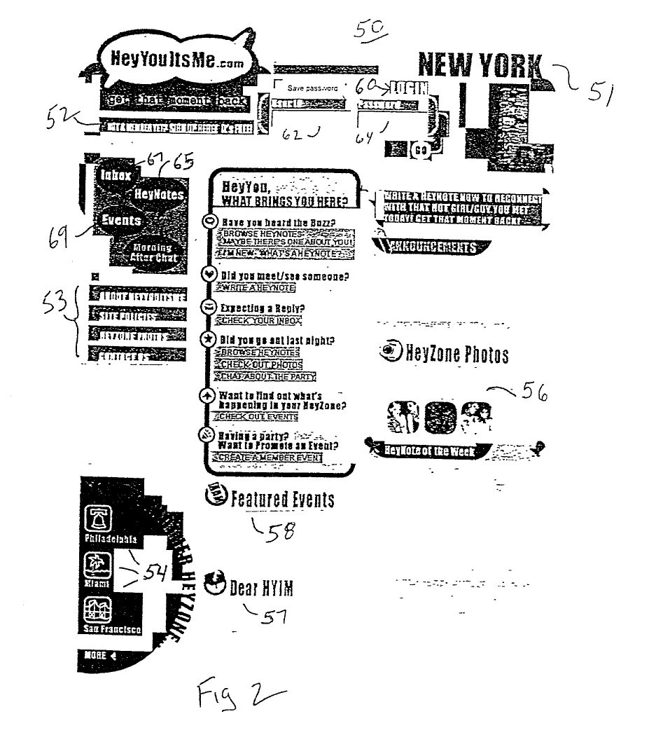

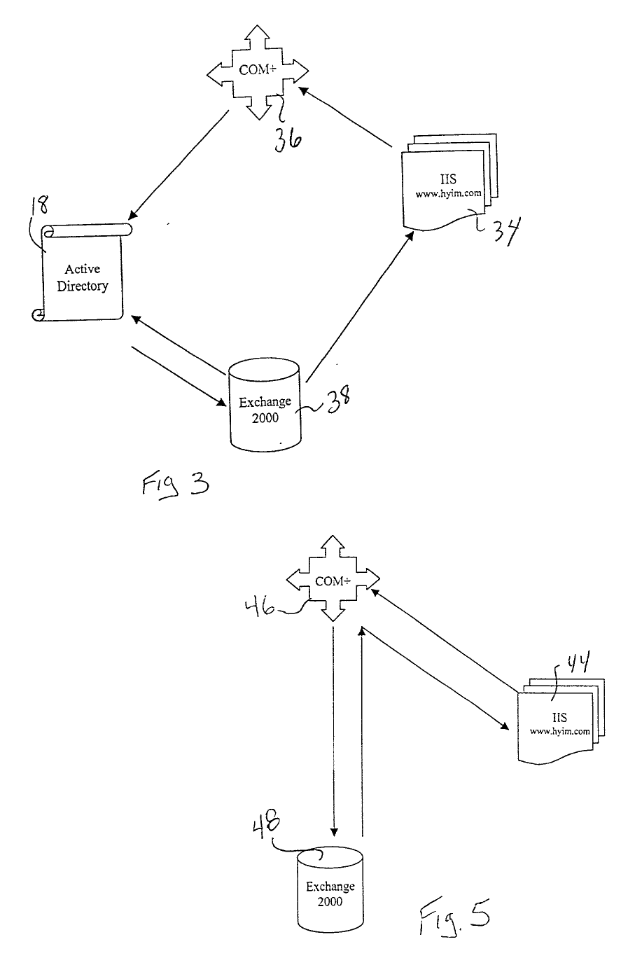

The new user registration process for the HeyYouItsMe web site is now described with respect to FIG. 2 which depicts an example HeyYouItsMe home page 50, including a new member registration link 52 enabling new members may sign up for a member account. In response to selecting sign-up link 52, the web-site application server 20 will generate a profile page (not shown) dynamically which will enable a new user to enter profile information. Specifically, as depicted in the process flow diagram of FIG. 3, implementing the HeyYoultsM IIS system component 34, a user first accesses the site and navigates to the new user signup page. A call is made to the Exchange2K.dll which is set up as a COM+ object 36 that has the ability to make modifications to data sources in other applications. In this case, Exchange2K.dll is invoked to create a new user account in the active directory 18 as it retains administration privileges. Preferably, information to be entered by new members includes, but is not limited to, a user ID, E-mail address, and password, etc. Once the appropriate information has been filled out, the user may select a “submit” button, which triggers not only the creation of his/her Active Directory user account using Active Server Pages and COM+ elements, but also the automatic creation of an E-mail address and mailbox on the exchange server. Particularly, the Exchange 2000 server 38 periodically queries the Active Directory 18 for updates to the user database and once the Exchange 2000 server receives a new user notification, it creates the E-mail address and mailbox for that user.

Referring back to the example generic home web-page 50 of FIG. 2, there is additionally displayed basic web-site information 53, a home “zone” indication 51 and links 54 to additional “zones”, which can also be set as default main pages on the site. According to the invention, as mentioned, a “HeyZone” is a collection of places, e.g., Chicago, The Hamptons, Woodstock, Mardi Gras, etc. usually defined geographically. At the initial visit to the HeyYouItsMe site, visitors are presented with a generic splash page (not shown) from which visitors are enabled to specify a HeyZone. Upon choosing a specified zone, the visitor will be taken to the home screen for that zone, such as the screen display 50 for the New York HeyZone. In completing the web-site registration page (not shown), the user chooses a default zone to which they will go (bypassing the splash page) when they go to the HeyYouItsMe web-site. The user's default home zone will be saved via a cookie on their computer.

As further shown in FIG. 2, basic web-site information 53 is established to provide knowledge and information regarding the site's intention and goals to visitors of the HeyYouItsMe community. These static areas will include: an “About the company” page which will display information regarding the intent and organization behind HeyYouItsMe; and, “Contact Information” will enable visitors to the site to forward e-mail regarding specific questions to the web-site administrators. Other areas may be displayed including: a “Testimonials” area 57 that may highlight personal successes gained through the use of the web-site, as well as an avenue to prove point of concept to potential members and advertisers; a Site Tour which may provide a brief overview of the site's functionality to ease understanding of the site to those less familiar with this concept of communication and opening of possibilities; and, a “Legal Stuff” area which would display legal disclaimers and site policies.

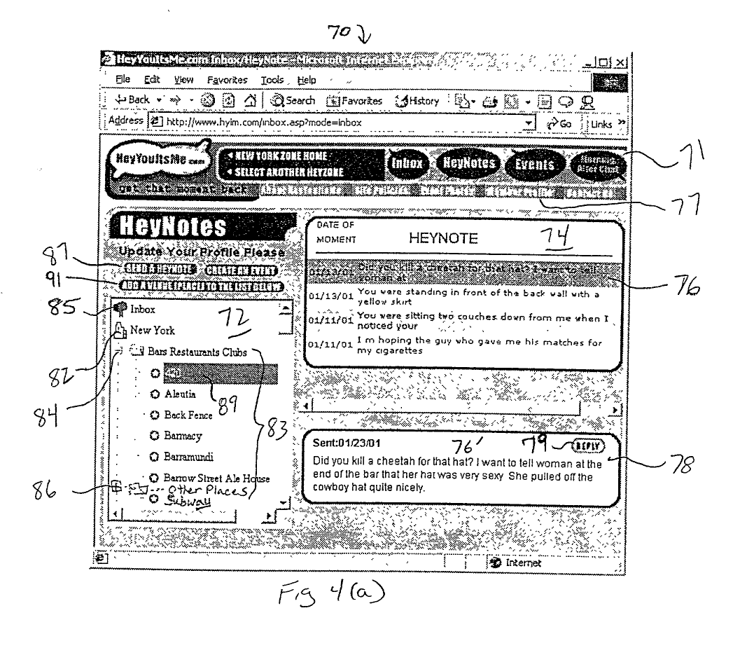

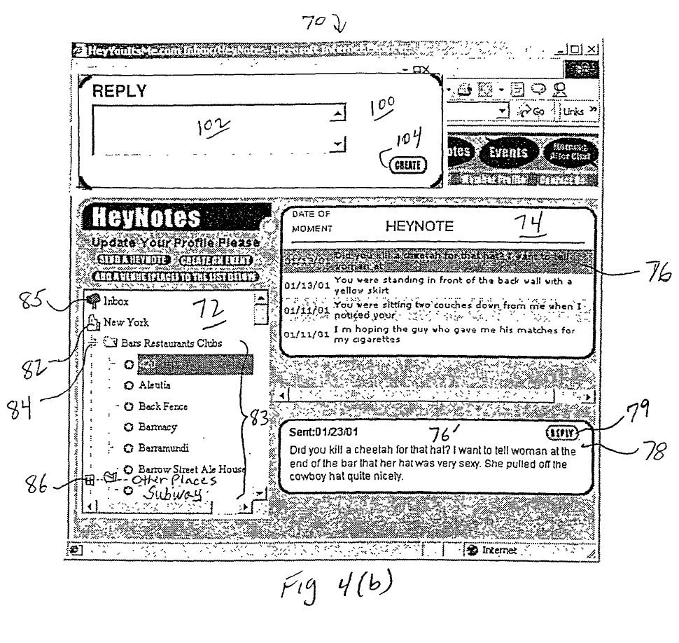

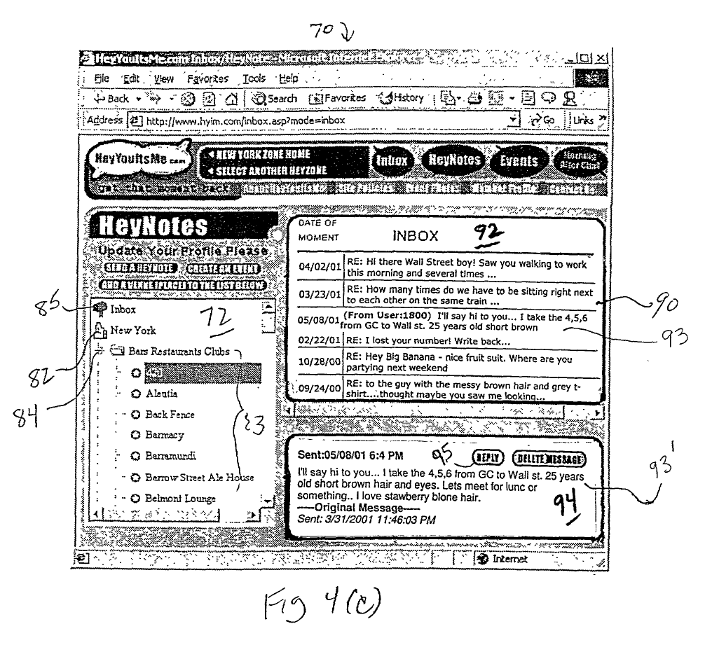

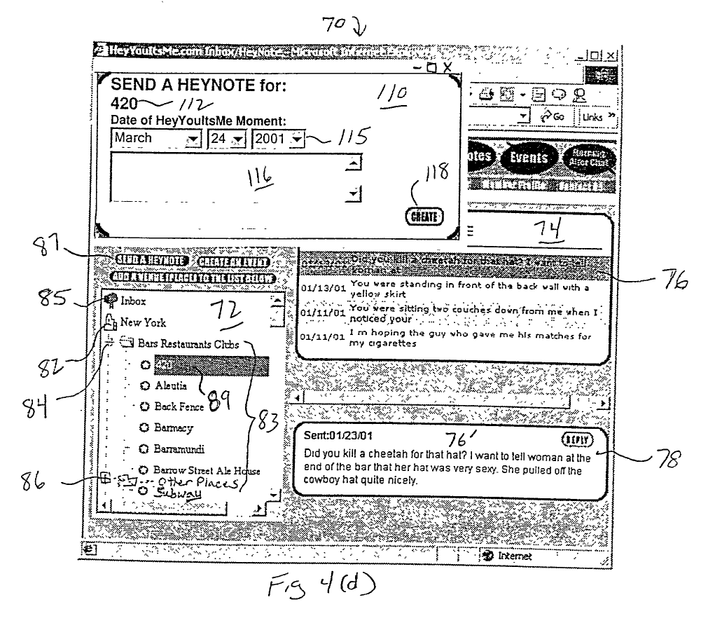

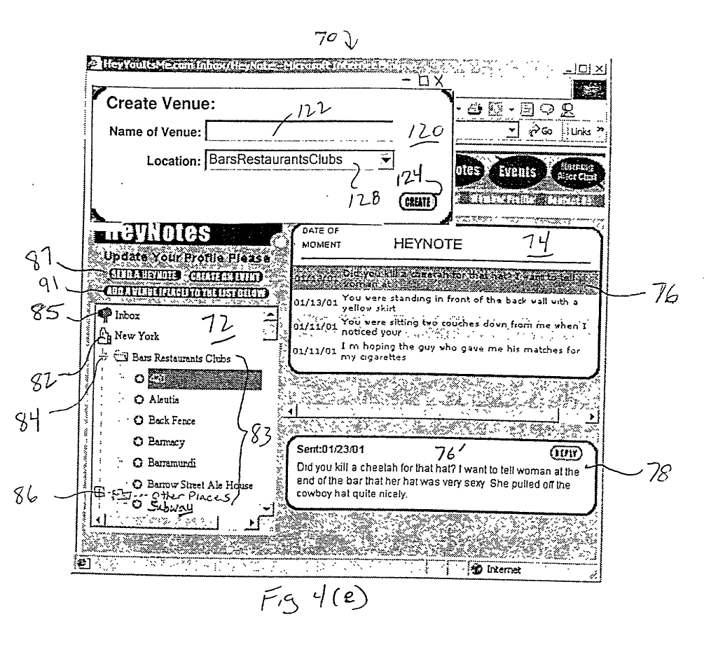

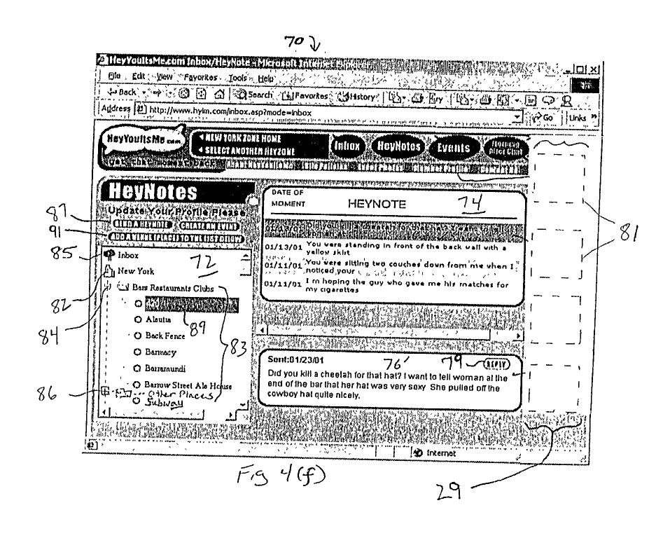

As further shown in FIG. 2, the selected “home zone” page 50 is additionally structured with an intuitive login capability 60 by which users may log in by entering their UserID 62 and Password 64. If a user member logs in and his/her password is validated, a default “zone” web-page (not shown) is generated that is virtually identical to FIG. 2, however, provides activated links that enable user access to all of the functionality provided by the web-site including: a HeyNotes™ link 65 that initiates generation and downloading of a web-page enabling user viewing and posting of messages specific to their chosen zone 51, as will be described herein with respect to FIG. 4(a); an inbox link 67 that initiates generation and downloading of a web-page enabling user access to their own personal inbox as will be described herein with respect to FIG. 4(c); and, a link 69 that initiates generation and downloading of a web-page enabling user viewing of summary details about specific upcoming events in the home zone area. It should be understood that the site is enabled to cater to specific cities or public events, i.e., zones, with a display component 54 providing the visitor with the option to traverse to another zone. Preferably, the structure of the default zone page will be the same across all zones, with the only information to change being the name and picture of the zone, sponsored events, and links to zone specific postings. In order to view postings in any zone, members and non-members must traverse this default zone page by logging in.

FIG. 4(a) is an example depiction of a HeyNotes™ web-page 70 presented to the user's web-browser in response to user selection of the HeyNotes™ link 65 from the default zone page. As will be described, this web-page 70 provides registered users with a tool bar 71 comprising links enabling access to the user's private Inbox and to every public aspect of the site, including a link 77 providing functionality for enabling member's to change profile preferences such as: removal of physical address, opting to receive weekly e-mails, changing default zone or changing password information.

More particularly, as shown in FIG. 4(a) there is provided a frame 72 that enables a user to navigate to and select a folder representing a particular zone 82 and venue category 83 such as a “Bars, Restaurant, Clubs” 84 or “Other place” 86, e.g., a subway, in order to browse and search all of the HeyNote messages posted for that selected zone/venue, or to enable the posting of HeyNote messages on the posting board for that selected zone/venue. Preferably, website members are able to search all postings via a free-text search mechanism or simply browse via a hierarchical venue structure. That is, as shown in HeyNotes™ frame 72, a top-level hierarchy under each zone 82 includes a top-level expandable/collapsible list of folders including: 1) Bars/Restaurants/Clubs 84; and, 2) Other Places 86. It should be understood that the hierarchy may further include a top-level list of folders including: 3) Sponsored Events and 4) Member Events. The venues 83 listed in the hierarchical structure are specifically represented as public folders in the application running on the Exchange 2000 server of the web-site. Preferably, public folders are publicly accessible depositories of messages submitted by users. Thus, a HeyNote message will be viewable by anyone with access to the site when they navigate to the venue in question as will be described in greater detail herein.

It should be understood that in addition to the navigation feature built in to the system, a search capability may be provided to help visitors locate specific venues/locations for message posting. Further to this, separate posting / browse areas, content pages and targeted event listings may be provided for targeted users. For example, if licensed to another entity such as, for example, www.gay.com, separate post/view areas may be provided in accordance with sexual preference/orientation. More advanced searching capabilities that could include pattern matching or a component to help users narrow down search criteria, such as searching by a type of post.

As shown in FIG. 4(a), with respect to browsing and searching, upon user selection of a zone 82 and venue 83, a posting board frame 74 which is a public folder populated with all of the HeyNote message listings for the selected venue. In one embodiment, as shown in FIG. 4(a), the frame 74 particularly provides a truncated display of each message, e.g., message 76, with the corresponding completed message 76′ displayed in a separately viewable frame 78. As shown in the detailed message viewing frame 78, a “reply” link 79 is provided that enables a user to reply to a specific HeyNote message. Thus, as a result of browsing the public message postings of a particular zone/venue in hopes of recapturing a moment with another, if a user finds a particular message directed to him/her by virtue of that prior moment, that user may select the reply link 79. In response to user selection of the reply link, a reply window is generated and displayed for the user as shown in FIG. 4(b).

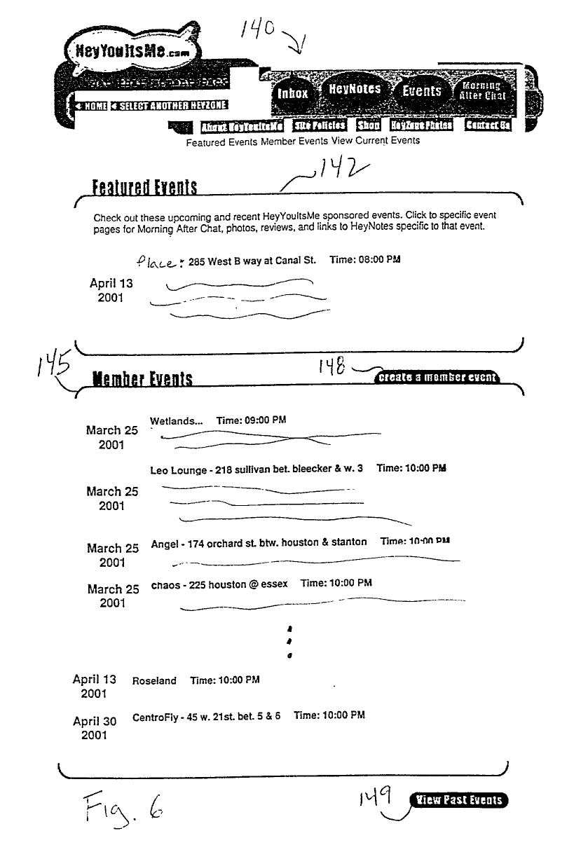

FIG. 4(b) particularly shows the superposition of a pop-up reply window 100 displayed at the user's browser that includes: a reply entry field 102 enabling entry of a reply message, and a create link 104 enabling the generation and transmission of an e-mail message comprising the user's reply to the first user's private mailbox (not shown). According to the invention, the Exchange 2000 functionality provides the mechanism for enabling posting and reply of messages. That is, as mentioned, a public folder is a data source on the Exchange server that allows for notes to be posted for public viewing. When a user posts a note to a public folder they are sending it from their e-mail address. Responding to a note found in a public folder via pop-up window 100 of FIG. 4(b), is like responding to any e-mail; the response automatically goes only to the mailbox (inbox) of the user who originally posted the HeyNote. Because a response to a heynote is actually an e-mail to an individual mailbox, only the individual who owns that mailbox will see the response. Furthermore, the first user, after receiving an e-mail reply message, is enabled to respond back to the user who sent the reply. It should be understood that any response to the reply will only be sent to the original replier's mailbox and will be visible only by them—thus resulting in a private conversation. In this situation, the Exchange2K dll is invoked to make changes to various Exchange Server databases, one of which is the public folder database, while the other is the mailbox store. A HeyYou.dll is responsible for displaying these changes. The actual mechanism is very similar to the “HeyNote” creation process as will be described herein with respect to FIG. 5.

It should be understood that any member who chooses to respond to a particular message posting does so anonymously. Preferably, internal email addresses are masked so that members cannot see any other member's name, however they will be able to create a private dialogue via e-mail by responding to one another's e-mails. As will be described, e-mails will be presented to the member in their Inbox via a conversation view in Exchange 2000. Members will not be able to send or receive any outside email, i.e., all e-mail is confined to the HeyYouItsMe web-site. Even though members must change zones to view postings in different zones, each member's Inbox view will carry across all zones.

Referring back to FIG. 4(a), more specifically, a user is enabled to select an Inbox link 85 that generates a web-page 70 as shown in FIG. 4(c). It is understood that the user's Inbox is directly accessible from an indicated link from the tool bar 71, or even directly from link 67 provided at the user's home page (FIG. 2). Upon selection of the Inbox link 85 functionality is invoked for retrieving all e-mail reply messages that have been stored at the users Inbox in the server database 19 (FIG. 1) and populating a web-page conversation view depicted in FIG. 4(c). FIG. 4(c) particularly illustrates an example inbox web-page conversation view including a scrollable Inbox frame 90 comprising truncated versions of all e-mail message replies that have retrieved from the user's Inbox. Particularly, e-mail message reply excerpts are provided in a display area 92 and the user is enabled to select the message excerpt, for example, message excerpt 93, and view the complete individual message, e.g., message 93′ in a scrollable display area 94. As further shown in FIG. 4(c), the user is enabled to reply again to the originator of the reply message by selecting reply link 95.

Referring back to FIG. 4(a), with respect to posting of HeyNote messages on the posting board for a selected zone/venue 82, 83, a link 87 is provided that enables a user to post a specific HeyNote message. After selecting and highlighting a particular venue, e.g., club 89 in the bars restaurants and clubs venue 86, in hopes of recapturing a prior HeyYouItsMe moment with another, a user may select link 87 which initiates generation of a pop-up HeyNote send window 110 as shown in the example web-page view of FIG. 4(d). FIG. 4(d) particularly shows the superposition of a pop-up HeyNote creation window 110 displayed at the user's browser that is populated with the currently selected venue such as venue 89 shown highlighted in the navigation frame 72, and provides entry fields enabling entry of the date 115 of the HeyYouItsMe moment, a field 116 enabling entry of the reconnect message the user wishes to send, and a create link 118 enabling the generation and transmission of an e-mail message comprising the user's HeyYouItsMe reconnect message. As mentioned, the contents of the HeyYouItsMe reconnect e-mail message is posted to a public folder which may be displayed via posting board frame 74 (FIG. 4(a)) and accessed by all registered users.

The specific process for sending and posting a “HeyNote” message for a particular venue according to the invention is now described with reference to FIG. 5. When a “HeyNote” is sent via the IIS functions 44, two COM+ objects 46 are put to work, including a HeyYou.dll and the Exchange.dll which coordinate to post the HeyNote message in the appropriate public folder maintained on the Exchange server 48 and display it to all users. The Exchange.dll particularly functions to insert the HeyNote in the public folder and, once posted, the HeyYou.dll displays the updated information on the web-site. It is understood that the Active Directory is implemented primarily for authentication purposes, i.e., approving of a user or service account's right to perform the message posting actions and manipulation of the various databases that constitute the Exchange Server's information store.

Referring back to FIG. 4(a), with respect to posting of HeyNote messages on the posting board, it may be the case that a particular venue is not listed. Thus, according to the invention, as shown in FIG. 4(a), a link 91 is provided that enables a user to add a venue to the hierarchical expandable/collapsible hierarchical zone/venue list provided in the web-page display 70. Particularly, selecting link 91 initiates generation of a pop-up window 120 as shown in the example web-page view of FIG. 4(e). FIG. 4(e) particularly shows the superposition of a pop-up add venue window 120 displayed at the user's browser that includes an entry field 122 enabling entry of the new venue to be added, an entry field 128 enabling entry via a pull-down menu, of the top-level location where the new venue is to be added, and a create link 124 enabling the generation and registering of a public folder functioning as the repository of HeyNote message creations specific to that venue. While the possibility exists that multiple places may be created by members for the same place, it is the job of the site administrators to review and combine postings and places. To view or create postings outside of a member's default zone, the member will be required to navigate to the default page of the different zone and continue to the area of that zone where postings are listed.

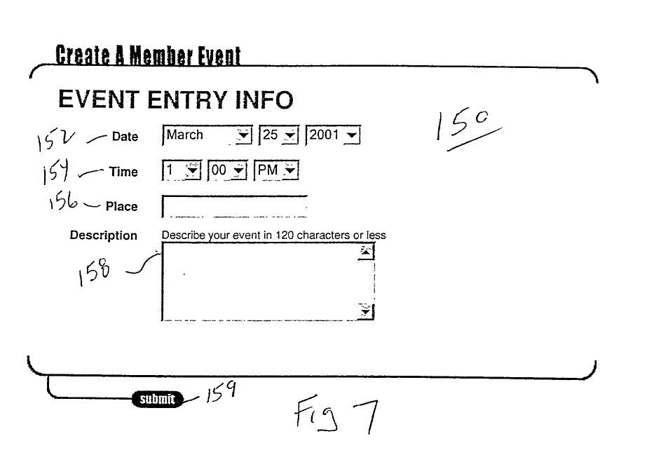

According to a further aspect of the invention, planned events coordinated by third-party event organizers may be posted on the website specific to the area or zone where the event will occur. In addition, members of the community may post their own member sponsored events on the website, which would have no affiliation with the HeyYouItsMe organization. As mentioned, referring back to FIG. 2, users are enabled to view summary details about specific upcoming third-party and member sponsored events in the home zone area by selecting link 69, or, by selecting the events link provided in the tool bar 71 from the HeyNotes™ web-page 70. Particularly, selecting the “events” link initiates the web-server to generate and download a web-page enabling user viewing of these events. FIG. 6 depicts an example web-page 140 comprising a first chronologic list 142 of upcoming events featured by organizers of the HeyYouItsMe.com web-site, and a second chronologic list 145 of upcoming private events that members wish to display such as events that may be promoted by an individual member or venue, e.g., bar, restaurant or club. It should be understood that featured parties at local bars/restaurants/clubs or other local events may be posted in display area 58 in the corresponding zone's main/index page (e.g., as shown in FIG. 2), preferably with links to pages containing more detailed information about the particular event.

According to the invention, all members have the ability to post their own private events with the hope of attracting other members'attendance of their personal Thus, as shown in the example web-page of FIG. 6, a link 148 is provided that enables a user to create an event. User selection of link 148 generates display of a pop-up “Create a Member Event” window 150, an example of which is depicted in FIG. 7. FIG. 7 particularly shows a pop-up create event window 150 displayed at the user's browser that includes an entry field 152 enabling entry of the date of the upcoming event, an entry field 154 enabling entry of a time the event is to take place, and entry field 156 enabling entry of the venue where the event is to take place, and an entry area 158 enabling a user to enter a description of the event. After filling out the details of the upcoming event, a user may submit the event by clicking submit button 159 which initiates creation and storage of the upcoming event notification message in a public folder functioning as the repository of such event messages and which will be immediately viewable. Functionality may be built in that enables retraction or indicate cancellation of an event.

Referring back to the example web-page of FIG. 6, a link 149 is provided that enables a user to view past events (featured or member events). As an added feature, via links (not shown) associated with past event, a “chat” session may be scheduled at the time posted with the event. Chat functionality is thus built into a site with the focus of the chat revolving around the specified past event. Preferably, these chats are linked from the events web-page 140, with scheduled chats enabling users to discuss events in an open forum soon after the scheduled event has occurred.

Referring to FIG. 2, a HeyZone photo display area 56 is provided that enables posting of photographs and user viewing of event photos from recent Featured and Member Events, or, from any of the places in the HeyZone.

Besides being able to facilitate on-line connections, the HeyYouItsMe web-site is able to deliver valuable (targeted and effective) messages for national, regional, and local advertisers. That is, the geographic (“HeyZone” -specific) nature of each user interaction enables local and regional advertisers to target consumers in the most relevant market(s). The fact that users navigate to specific venues to read and post HeyNotes™ enables the web-site to serve advertisements for products/brands whose users match a pre-determined set of characteristics associated with each venue in HeyYouItsMe, e.g., a theme bar catering to 21 year old age group.

Through use of WebTrends™, or other web-site monitoring system, the application owners are thus enabled to approach potential advertisers and site sponsors to increase advertising on the website. Additionally, at the browse level, targeted advertising will be displayed according to the visitor's interaction at either the zone or place level or a combination of both. Through links and/or partnerships with outside vendors, users may additionally be able to purchase merchandise, such as flowers or jewelry via a link to the vendor from the HeyYouItsMe website. FIG. 4(f) is an example depiction of a HeyNotes™ web-page 70 including a display area 29 comprising a plurality of advertisements (ads) 81 paid for advertisers and site sponsors presented to the user's web-browser.

An “Ad Rotator” mechanism may be used to control which advertisements 81 are viewed in the HeyNotes/Inbox areas, depending upon which specific venue is selected by the user. The application owners may associate the venues on the site with presumed specific characteristics of the people who frequent those venues off-line. Those characteristics may be matched against entries on a similar list which describes users of advertisers'products or services. In that way, users selecting a particular HeyNote venue on the site will see a set of ads determined by this data-matching process.

While advertising / sponsorship is a primary revenue source, there are other planned sources as well, including e-commerce. As a local content and entertainment destination, the HeyYouItsMe.com web-site may offer targeted merchandise related to particular geographic areas or places (HeyZones) and to the events and venues in those locations. As a destination related to dating and meeting people, HeyYouItsMe.com is able to offer gifts and other purchase opportunities, such as flowers, CDs, and movie/concert tickets. The nature of the site offers an interesting twist to buying items such as flowers and small gifts: they can be delivered anonymously to other users without the identity or location of either party being divulged. That is, an on-line store is provided that enables members to purchase items to be physically sent to other members anonymously without disclosing any physical addresses to other members.

There are other potential revenue sources such as event and venue promotion. Clubs and venues in most major metropolitan areas currently use local promoters to attract people to specific events and parties. These promoters typically keep the cover (entry) fees charged to attendees, less the expenses associated with the particular event. The venues forego this income in favor of the (highly profitable) bar tab for the event, for example. HeyYouItsMe.com web-site thus may function to collect sponsorship fees from local venues in return for event promotion on the site and in member communications (e-mail).

Other e-commerce components include: charging for membership by either a monthly or yearly basis or inclusion of a credit system where members would purchase blocks of credits that would be used to pay for individual actions, for example, message postings would cost three (3) credits. Additionally, included is the ability for members to purchase space in the community to advertise and fully promote information regarding a member created event.

In addition to fees related to specific events, HeyYouItsMe could pursue fee arrangements with venues for enhanced promotion on the site. For example, a venue might pay an annual fee in order to include more information when a user s browsing the HeyNote™ in that venue: location, directions, and links to its website, menu, recent review, table reservations, and so on.

Additional site fees may be charged for enhanced user services. For example, any site user may be charged a fee for creating and promoting a Member Event, which is listed on the site, mentioned in weekly e-mails, or added to the list of places from which users can send and browse HeyNotes™.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A method for extending off-line experiences between parties in an on-line context over a public communications network, said method including the steps of:
a) accessing a list of folder structures for on-line viewing via a web-browser device, each said folder structure associated with a particular location where a prior off-line experience had taken place and including one or more messages submitted by persons that relate to continuing a specific prior interaction involving said person and another at said location;
b) enabling said another person to select a folder and initiating display via said web-browser device of all messages submitted by users regarding their prior interactions at a selected location;
c) enabling said another person to select a message recognized as being submitted by said person and relating to a specific prior off-line experience with said person; and
d) in response to said selection, providing a link enabling user generation of a confidential reply message for continuing said prior off-line experience between said person and said another in an on-line context via said public communication network.

2. The method for extending off-line experiences between parties as claimed in claim 1, wherein prior to said step a), the step of:
enabling a first person to generate a message by specifying information including: a time and location where said prior off-line experience with a second person had taken place; and,
communicating said message over a public network for storage in said public accessible folder associated with the specified location.

3. The method for extending off-line experiences between parties as claimed in claim 1, wherein said location includes a particular venue.

4. The method for extending off-line experiences between parties as claimed in claim 1, wherein said location includes a particular event.

5. The method for extending off-line experiences between parties as claimed in claim 2, wherein each person submitting a message has an associated inbox for receiving and storing e-mail messages, said step d) of providing a link enabling generation of s aid reply message includes:
displaying entry window enabling a second person to enter a reply message via said web-browser device;
formulating an e-mail including said reply message; and,
transmitting said e-mail over said public communications network for automatic input to an inbox of said person for subsequent retrieval, wherein said inbox is not publicly accessible.

6. The method for extending off-line experiences between parties as claimed in claim 2, wherein prior to said accessing step a), the step of organizing said list of public folders for display as a hierarchy of zones and locations within each zone, said accessing including the step of navigating to a particular location via said hierarchy.

7. The method for extending off-line experiences between parties as claimed in claim 6, further including the step of creating a new public folder associated with a new location not listed in said view of publicly available folders.

8. The method for extending off-line experiences between parties as claimed in claim 3, further including the step of initiating the display of advertisements associated with products and services of third party entities via said web-browser device.

9. The method for extending off-line experiences between parties as claimed in claim 8, further including the steps of selecting and displaying advertisements targeted for users having a presumed set of characteristics associated with a current selected venue location.

10. A system for extending off-line experiences between parties including:
memory storage device including a plurality of folders, each folder associated with a particular location and each functioning as a repository of messages submitted by users that relate to continuing a specific prior interaction involving said person and another at said location;
server means enabling communication over a public network of a list of said folders for on-line viewing via a web-browser, each said folder being selectable by a user via a selection device;
mechanism responsive to user selection of a folder for displaying all messages submitted by users that are associated with the selected folder, each said message being selectable by a user via said selection device and including a link facilitating continuation of said prior off-line experience between said parties at said location;
mechanism enabling a user to activate said link and initiate generation of a user reply message for continuing said prior off-line experience in an on-line context via said communication network.

11. The system as claimed in claim 10, further comprising:
means for enabling generation of messages including specification of a time and location where said prior off-line experience with a second person had taken place; and,
communication device for enabling transmission of said message over a network for storage in said folder associated with the specified location.

12. The system as claimed in claim 10, wherein said location includes a particular venue.

13. The system as claimed in claim 10, wherein said location includes a particular event.

14. The system as claimed in claim 11, wherein said user reply message comprises an e-mail, said system further comprising: privately accessible inbox storage device associated with a user sending messages for receiving and storing e-mail reply messages and accessing said messages via said communications network, wherein said user generated reply messages are input automatically to an inbox of said person for subsequent retrieval.

15. The system as claimed in claim 11, further comprising mechanism for organizing said list of folders as a hierarchy of zones and locations within each zone.

16. The system as claimed in claim 13, further including means for creating a new folder structure associated with a location not listed in said view of publicly available folders.

17. The system as claimed in claim 12, further including an ad rotator mechanism for displaying advertisements associated with products and services of third party entities for viewing by a user via said web-browser, said ad rotator mechanism selecting and displaying advertisements targeted for users having a presumed set of characteristics associated with a current selected venue location.

18. A program storage device readable by a machine, tangibly embodying a program of instructions executable by the machine to perform method steps for extending off-line experiences between parties in an on-line context over a public communications network, said method steps comprising:
a) accessing a list of folder structures for on-line viewing via a web-browser device, each said folder structure associated with a particular location where a prior off-line experience had taken place and including one or more messages submitted by persons that relate to continuing a specific prior interaction involving said person and another at said location;
b) enabling said another person to select a folder and initiating display via said web-browser device of all messages submitted by users regarding their prior interactions at a selected location;
c) enabling said another person to select a message recognized as being submitted by said person and relating to a specific prior off-line experience with said person; and
d) in response to said selection, providing a link enabling user generation of a confidential reply message for continuing said prior off-line experience between said person and said another in an on-line context via said on-line communication network.

19. A web-based connection service for extending off-line experiences between persons in an on-line context comprising:
server device for transmitting web-based communications over a public communications network, for causing the display, via a receiving web-browser device, of message notes posted by persons having had a prior interaction with another at a particular location or event, said message notes organized for display in accordance with a particular location or event and being public accessible for selection by users;
mechanism associated with each message for enabling user generation of a reply e-mail message by another and dispatch of said message confidentially for receipt by a poster of the selected message, whereby a private dialogue between parties wishing to extend off-line experiences at said venue via e-mail is enabled.

20. The web-based connection service as claimed in claim 19 further comprising a privately accessible inbox storage device associated with a user posting messages for receiving and storing reply e-mail messages and enabling access to said messages via said web-browser device.

21. The web-based connection service as claimed in claim 19 further comprising a mechanism for initiating display of advertisements associated with products and services of third party entities for viewing by a user via said web-browser, said ad rotator mechanism selecting and displaying advertisements targeted for users having a presumed set of characteristics associated with a current selected venue or event.

22. A method for extending off-line experiences between persons in an on-line context comprising:
a) transmitting web-based communications over a public communications network, for causing the display, via a receiving web-browser device, of message notes posted by persons having had a prior interaction with another at a particular location or event, said message notes organized for display in accordance with a particular location or event and being public accessible for selection by users; and, in response to user selection of a message note,
b) enabling user generation of a reply e-mail message by another and dispatch of said message confidentially for receipt by a poster of the selected message,
whereby a private dialogue between parties wishing to extend off-line experiences at said venue via e-mail is enabled.

23. The method as claimed in claim 22, wherein step b) includes the step of:
receiving and storing reply e-mail messages in a privately accessible inbox storage device associated with a user posting messages; and,
enabling user access to said messages via said web-browser device.

24. The method as claimed in claim 22, further comprising the steps of:
initiating display of advertisements associated with products and services of third party entities for viewing by a user via said web-browser; and,
selecting and displaying advertisements targeted for users having a presumed set of characteristics associated with a current selected venue or event.
